(19) United States
(12) Patent Application Publication
(10) Pub. No.: US 2008/0031544 A1
(43) Pub. Date: Feb. 7, 2008

(54) Tilt Detection Method and Entertainment System

(76) Inventors: Hiromu Ueshima, Shiga (JP); Keiichi Yasumura, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/574,893

(22) PCT Filed: Sep. 1, 2005
(86) PCT No.: PCT/JP05/16468

§ 371 Date: May 8, 2007

(30) Foreign Application Priority Data
Sep. 9, 2004 (JP) 2004-262275

(51) Int. Cl. G06K 9/36

(52) U.S. Cl. 382/289

(57) ABSTRACT

A retroreflective sheet 13 (a sword 11) is imaged to obtain the maximum X-coordinate “maxX”, minimum X-coordinate “minX”, maximum Y-coordinate “maxY” and minimum Y-coordinate “minY” thereof. The pixel having the maximum luminance value among a plurality of pixels of which the X-coordinates are the maximum X-coordinate “maxX” is detected to acquire the Y-coordinate “AY[maxX]” of the pixel, while the pixel having the maximum luminance value among a plurality of pixels of which the X-coordinates are the minimum X-coordinate “minX” is detected to acquire the Y-coordinate “AY[minX]” of the pixel. Furthermore, a first characteristic point (X1, Y1) and a second characteristic point (X2, Y2) are determined on the basis of the result of comparing the Y-coordinate “AY[maxX]” and the Y-coordinate “AY[minX]”, and the tilt angle “An” of the sword 11 is calculated.

### TECHNICAL FIELD

The present invention relates to a tilt detection method and the related techniques for detecting the tilt of an operation article by taking stroboscopic images of the operation article having a reflecting object.

### BACKGROUND ART

Japanese Patent Published Application No. 2004-85524 by the present applicant discloses a golf game system including a game unit and a golf-club-type input device (operation article), and the housing of the game unit houses an imaging unit which comprises an image sensor, infrared light emitting diodes and so forth. The infrared light emitting diodes intermittently emit infrared light to a predetermined area above the imaging unit while the image sensor intermittently captures images of the reflecting object of the golf-club-type input device which is moving in the predetermined area. The location and speed of the golf-club-type input device can be detected by processing the stroboscopic images of the reflecting object.

### DISCLOSURE OF INVENTION

Accordingly, it is an object of the present invention to provide a tilt detection method and the related techniques for detecting the tilt of an operation article by processing stroboscopic images of a reflecting object provided of the operation article.

In accordance with an aspect of the present invention, a tilt detection method of detecting a tilt of an operation article which is held and given motion by an operator, comprises: a step of repeatedly emitting light to the operation article which has a reflecting object in a predetermined cycle; a step of imaging the operation article to which the light is emitted, and acquiring lighted image data including a plurality of pixel data items each of which comprises a luminance value; a step of imaging the operation article to which the light is not emitted, and acquiring unlighted image data including a plurality of pixel data items each of which comprises a luminance value; a step of generating differential image data by obtaining difference between the lighted image data and the unlighted image data; a step of obtaining a maximum X-coordinate of the operation article in a differential image on the basis of the differential image data; a step of obtaining a minimum X-coordinate of the operation article in the differential image; a step of obtaining a maximum Y-coordinate of the operation article in the differential image; a step of obtaining a minimum Y-coordinate of the operation article in the differential image; a step of detecting a pixel data item having a maximum luminance value from among a plurality of pixel data items of the differential image data whose X-coordinates are the maximum X-coordinate, and acquiring the Y-coordinate of the pixel data item; a step of detecting a pixel data item having a maximum luminance value from among a plurality of pixel data items of the differential image data whose X-coordinates are the minimum X-coordinate, and acquiring the Y-coordinate of the pixel data item; a step of comparing the Y-coordinate of the pixel data item having the maximum luminance value whose X-coordinate is the maximum X-coordinate and the Y-coordinate of the pixel data item having the maximum luminance value whose X-coordinate is the minimum X-coordinate, and determining which is greater; a step of obtaining the coordinates of a first characteristic point and the coordinates of a second characteristic point of said operation article in the differential image on the basis the result of the determination, the maximum X-coordinate, the minimum X-coordinate, the maximum Y-coordinate and the minimum Y-coordinate; and a step of obtaining the tilt of the operation article in the differential image on the basis of the coordinates of the first characteristic point and the coordinate of the second characteristic point.

In accordance with this configuration, it is possible to detect the tilt of the operation article on the basis of the stroboscopic images of the reflecting object of the operation article.

The tilt detection method further comprises a step of obtaining the difference between the maximum X-coordinate and the minimum X-coordinate; a step of obtaining the difference between the maximum Y-coordinate and the minimum Y-coordinate; and a step of obtaining the tilt of the operation article in the differential image in accordance with the ratio of the difference between the maximum X-coordinate and the minimum X-coordinate to the difference between the maximum Y-coordinate and the minimum Y-coordinate.

In accordance with this configuration, when the operation article is imaged with a particular tilt, it is possible to appropriately determine such a particular tilt. Particularly, this is effective in the case where the particular tilt is vertical or horizontal.

The tilt detection method further comprises a step of obtaining the orientation of the operation article in the differential image on the basis of the orientation of the operation article as obtained in the past and the tilt of the operation article as currently obtained.

In accordance with this configuration, it is possible to detect not only the tilt of the operation article but also the sense of the operation article.

In accordance with another aspect of the present invention, an entertainment system comprises: an operation article that is operated by a user when the user is enjoying said entertainment system; an imaging unit having a light emitting device operable to emit light to said operation article, and an image sensor operable to detect the light reflected by said operation article and acquire images of said operation article in different times; and an information processing apparatus connected to said image sensor, and operable to receive the images of said operation article from said image sensor and determine orientations of said operation article on the basis of the images of said operation article, wherein a tilt of an orientation of said operation article is calculated on the basis of the corresponding one of the images of said operation article acquired by said imaging unit, wherein a sense of an orientation of said operation article in a current image obtained by said imaging unit is determined by calculating the differential angle between each of two possible candidates of the orientations having the same tilt and a previous orientation determined on the basis of the image that is obtained by said imaging unit and timely preceding the current image, and selecting one of the two possible candidates having the smaller differential angle.

In accordance with this configuration, it is possible to quickly determine the sense of the orientation of said operation article.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a block diagram showings the entire configuration of a game system in accordance with an embodiment of the present invention.

FIG. 2 is a schematic diagram showing the electric configuration of the game unit 1 of FIG. 1.

FIG. 3 is a flowchart showing an example of the overall process flow of the game unit 1 of FIG. 1.

FIG. 4 is a flowchart showing an example of the imaging process of step S2 of FIG. 3.

FIG. 5 is a flowchart showing the process of scanning the differential signal “Dif[X][Y]” in step S4 of FIG. 3.

FIG. 6 is a schematic representation of the sword 11 in the differential image as captured by the image sensor 19 of FIG. 2 FIG. 7 is a flowchart showing an example of the process of calculating the respective coordinates “minX”, “maxX”, “minY” and “maxY” in step S34 of FIG. 5.

FIG. 8 is a flowchart showing an example of the process of vertical/horizontal judgment in step S5 of FIG. 3.

FIG. 9 is a flowchart showing an example of the process of calculating the tilt of the sword 11 in step S6 of FIG. 3.

FIG. 10 is an explanatory view for showing the tilt and sense of the sword 11 as determined by the game unit 1 of FIG. 1.

FIG. 11A is a view showing the sword 11 directed to the orientation a13 of FIG. 10.

FIG. 11B is a view showing the sword 11 directed to the orientation a29 of FIG. 10.

FIG. 12 is a flowchart showing an example of the process of detecting the orientation of the sword 11 in step S7 of FIG. 3.

FIG. 13 is a view showing examples of beltlike objects A0 to A8 generated by the game unit 1 of FIG. 1.

FIG. 14 is a view showing an example of the beltlike object A2 as displayed on the television monitor 7 of FIG. 1.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated. In accordance with the present embodiment, an operation article 11 in the form of a sword (referred to as the “sword 11” in the present embodiment) is described as an example of an operation article.

The opposite faces of the blade portion of the sword 11 are provided respectively with an elongated retroreflective sheet 13. The opposite sides of the guard portion of the sword 11 are provided respectively with a half-column portion having a round surface to which a retroreflective sheet 15 is attached.

A game unit 1 is connected to a television monitor 7 by an AV cable 9. Furthermore, although not shown in the figure, the game unit 1 is supplied with a power supply voltage from an AC adapter or a battery.

The game unit 1 is provided with an infrared filter 5 which is located in the front side of the game unit 1 and serves to transmit only infrared light, and there are four infrared light emitting diodes 3 which are located around the infrared filter 5 and serve to emit infrared light. An image sensor 19 to be described below is located behind the infrared filter 5.

The four infrared light emitting diodes 3 intermittently emit infrared light. Then, the infrared light emitted from the infrared light emitting diodes 3 is reflected by the retroreflective sheet 13 or 15 attached to the sword 11, and input to the image sensor 19 located behind the infrared filter 5. An Image of the sword 11 can be captured by the image sensor 19 in this way. While infrared light is intermittently emitted, the image sensor 19 performs the imaging process even in non-emission periods. The location, area, tilt, orientation and the like of the sword 11 can be detected in the game unit 1 by calculating the differential image signal between the image with infrared light and the image without infrared light when a player 17 swings the sword 11.

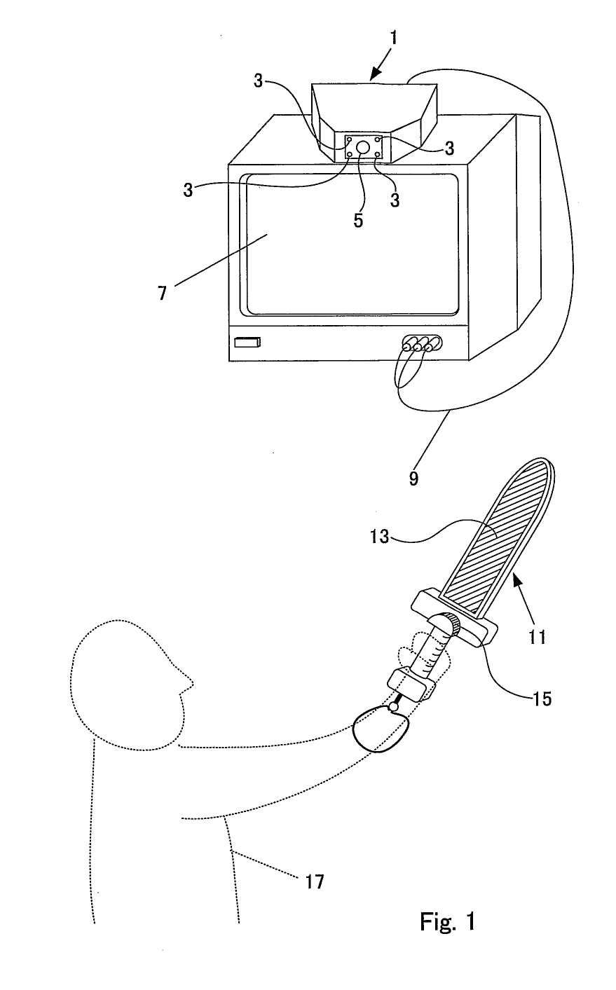

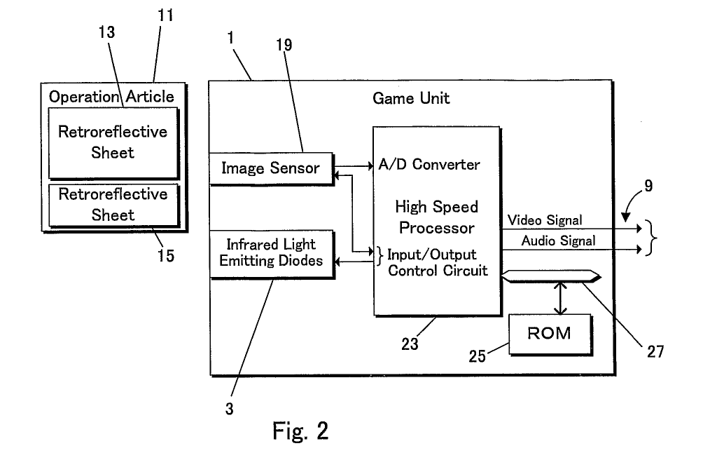

FIG. 2 is a schematic diagram showing the electric configuration of the game unit 1 of FIG. 1. As shown in FIG. 2, the game unit 1 includes the image sensor 19, the infrared light emitting diodes 3, a high speed processor 23, a ROM (read only memory) 25 and a bus 27.

The sword 11 is illuminated with the infrared light which is emitted from the infrared light emitting diodes 3 and reflected by the retroreflective sheet 13 or 15. The image sensor 19 receives the reflected light from this retroreflective sheet 13 or 15 for capturing an image, and outputs an image signal of the retroreflective sheet 13 or 15. This analog image signal from the image sensor 19 is converted into digital data by an A/D converter (not shown in the figure) implemented within the high speed processor 23. This process is performed also in the periods without infrared light. The high speed processor 23 lets the infrared light emitting diodes 3 intermittently flash for performing such stroboscopic imaging.

Although not shown in the figure, the processor 23 includes various functional blocks such as a CPU (central processing unit), a graphics processor, a sound processor and a DMA controller, and in addition to this, includes the A/D converter for accepting analog signals and an input/output control circuit for receiving input signals such as key manipulation signals and outputting output signals to external devices. The image sensor 19 and the infrared light emitting diodes 3 are controlled by the CPU through the input/output control circuit. The CPU runs a game program stored in the ROM 25, and outputs the results of operations to the graphics processor and the sound processor. Accordingly, the graphics processor and the sound processor perform image processing and sound processing in accordance with the results of the operations.

The high speed processor 23 is provided with an internal memory, which is not shown in the figure and is for example a RAM (random access memory). The internal memory is used to provide a working area, a counter area, a resister area, a temporary data area, a flag area and so forth.

The high speed processor 23 can access the ROM 25 through the bus 27. Accordingly, the high speed processor 23 runs the game program stored in the ROM 25, and reads and processes image data and sound data stored in the ROM 25.

The high speed processor 23 processes digital image signals as input from the image sensor 19 through the A/D converter, detects the location, area, tilt, orientation and the like of the sword 11, performs a graphics process, a sound process and other processes and computations, and outputs a video signal and an audio signal. The video signal and the audio signal are supplied to the television monitor 7 through the AV cable 9 in order to display an image on the television monitor 7 corresponding to the video signal while a sound is output from the speaker thereof (not shown in the figure) corresponding to the audio signal.

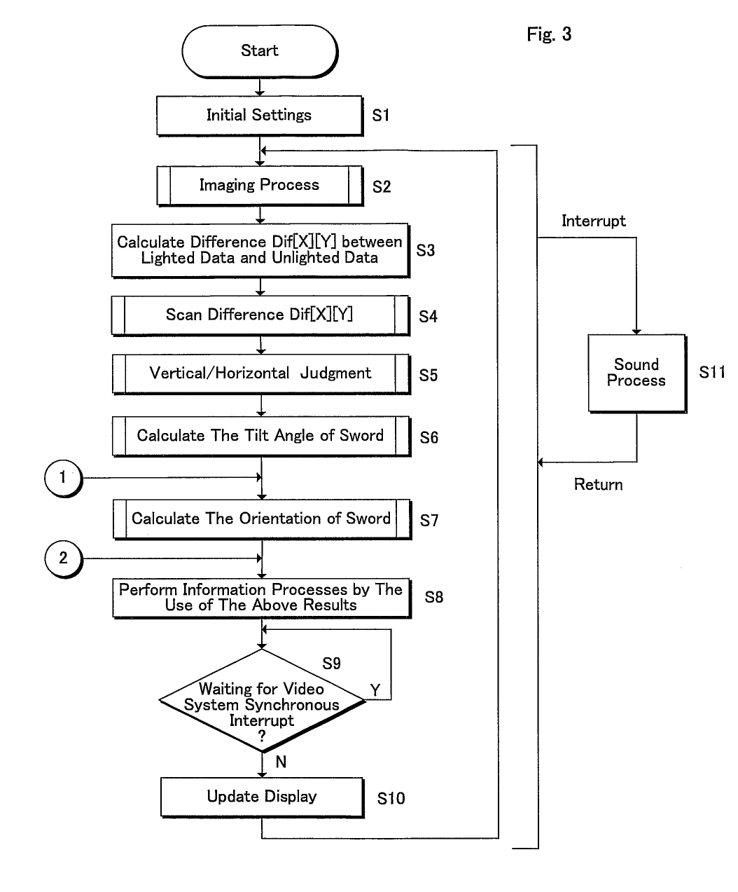

FIG. 3 is a flowchart showing an example of the overall process flow of the game unit 1 of FIG. 1. As shown in FIG. 3, the high speed processor 23 performs the initial settings of the system in step S1. In step S2, the high speed processor 23 performs the process of imaging the sword 11 by driving the infrared light emitting diodes 3.

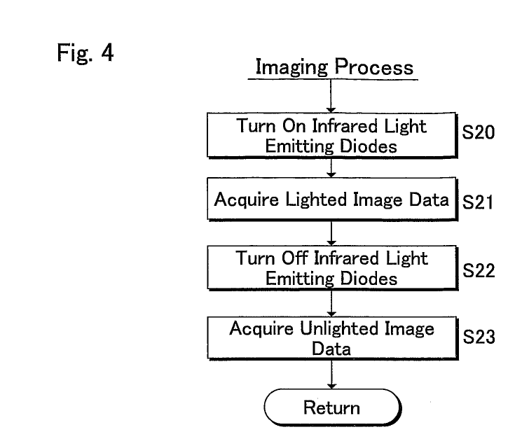

FIG. 4 is a flowchart showing an example of the imaging process of step S2 of FIG. 3. As shown in FIG. 4, the high speed processor 23 turns on the infrared light emitting diodes 3 in step S20. In step S21, the high speed processor 23 acquires image data from the image sensor 19 with infrared light, and stores the image data in the internal memory.

In this case, for example, a CMOS image sensor of 32 pixels×32 pixels is used as the image sensor 19 of the present embodiment. Also, it is assumed that the horizontal axis is X-axis and the vertical axis is Y-axis. Accordingly, 32 pixels×32 pixels of pixel data (luminance data for each pixel) is output as image data from the image sensor 19. This pixel data is converted into digital data by the A/D converter and stored in the internal memory as an array element “P1[X][Y]”.

In step S22, the high speed processor 23 turns off the infrared light emitting diodes 3. In step S23, the high speed processor 23 acquires, from the image sensor 19, image data (32 pixels×32 pixels of pixel data (luminance data for each pixel)) without infrared light, and stores the image data in the internal memory. In this case, this pixel data is stored in the internal memory as an array element “P2[X][Y]”.

The stroboscope imaging is performed in this way. Meanwhile, since the image sensor 19 of 32 pixels×32 pixels is used in the case of the present embodiment, X=0 to 31 and Y=0 to 31 while the origin is located at the upper left corner.

Returning to FIG. 3, in step S3, the high speed processor 23 calculates the differential data between the pixel data “P1[X][Y]” acquired when the infrared light emitting diodes 3 are turned on and the pixel data “P2 [X][Y]” acquired when the infrared light emitting diodes 3 are turned off, and the differential data is assigned to an array element “Dif[X][Y]”.

As thus described, it is possible to eliminate, as much as possible, noise of light other than the light reflected from the sword 11 (the retroreflective sheets 13 and 15) by calculating the differential image data (i.e., 32 pixels×32 pixels of the differential data), and accurately detect the sword 11 (the retroreflective sheets 13 and 15).

In step S4, the high speed processor calculates the location, area, minimum X-coordinate “minX”, maximum X-coordinate “maxX”, minimum Y-coordinate “minY”, maximum Y-coordinate “maxY” and so forth of the sword 11 by scanning the differential image data, i.e., the array elements “Dif[X][Y]”.

In step S5, the high speed processor 23 determines if the sword 11 is vertical or horizontal. In step S6, the high speed processor 23 determines the tilt of the sword 11 if the sword 11 is not vertical or horizontal. In step S7, the high speed processor 23 determines the orientation of the sword 11.

In this case, the “tilt” of the sword 11 is a scalar quantity having only the magnitude of the tilt while the “orientation” of the sword 11 is a vector quantity having the sense and magnitude of the tilt.

In step S8, the high speed processor 23 performs information processes by making use of the processing results in steps S4 to S7.

The high speed processor 23 repeats the same step S9, if “YES” is determined in step S9, i.e., while waiting for a video system synchronous interrupt (while there is no video system synchronous interrupt). Conversely, if “NO” is determined in step S9, i.e., if the CPU gets out of the state of waiting for a video system synchronous interrupt (if the CPU is given a video system synchronous interrupt), the process proceeds to step S10. In step S10, the high speed processor 23 performs the process of updating the screen displayed on the television monitor 7, and the process proceeds to step S2.

The sound process in step S11 is performed when an audio interrupt is issued for outputting music sounds, and other sound effects.

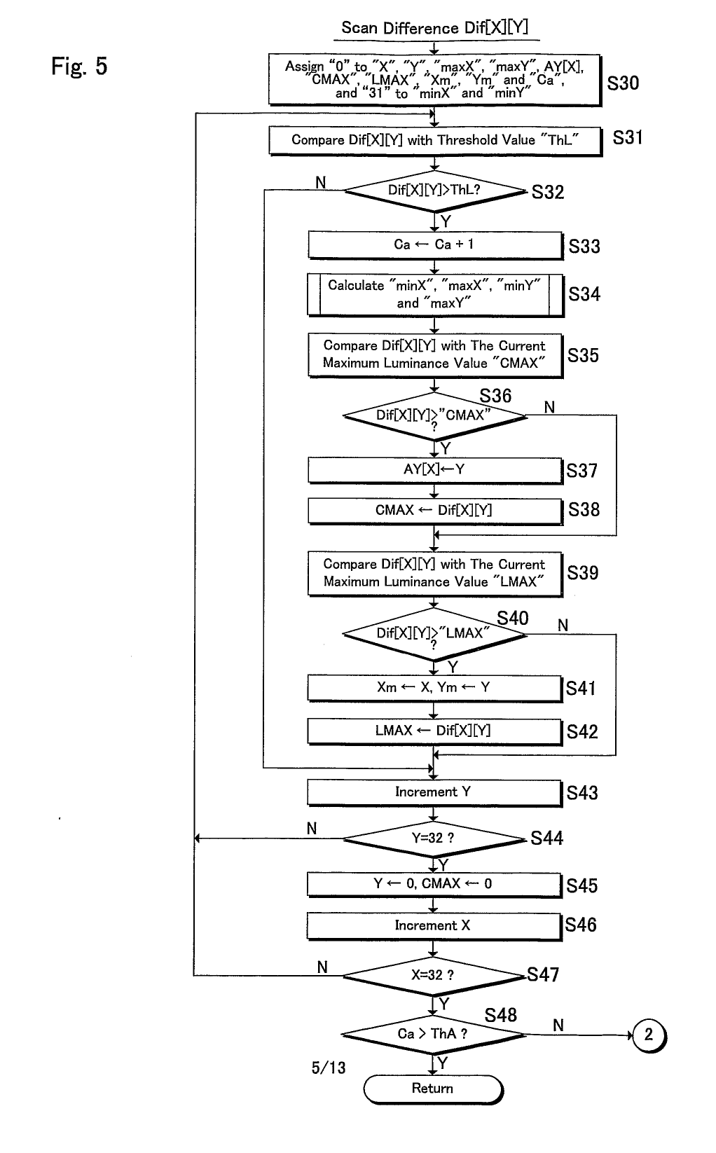

FIG. 5 is a flowchart showing the process of scanning the differential image data (i.e., the array elements “Dif[X][Y]”) in step S4 of FIG. 3. As shown in FIG. 5, the high speed processor 23 assigns “0” respectively to the variables “X”, “Y”, “maxX”, “maxY”, “AY[X]”, “CMAX”, “LMAX”, “Xm”, “Ym” and “Ca” in step S30. In addition, the high speed processor 23 assigns “31” to the variables “minX” and “minY” in the same step S30.

In step S31, the high speed processor 23 compares the array element “Dif[X][Y]” with a predetermined threshold value “ThL”. In step S32, If the array element “Dif[X][Y]” is larger than the predetermined threshold value “ThL”, the high speed processor 23 proceeds to step S33, and conversely if the array element “Dif[X][Y]” is not larger than the predetermined threshold value “ThL”, the high speed processor 23 proceeds to step S43.

The process in steps S31 and S32 is the process for detecting whether or not the retroreflective sheet 13 or 15 is imaged. Since the luminance values of the pixels corresponding to the retroreflective sheet become greater than those of the other pixels in the differential image when the retroreflective sheet 13 or 15 is imaged, the significances of the luminance values are judged with reference to the threshold value “ThL” so that the pixels having a luminance value larger than the threshold value “ThL” are recognized as the retroreflective sheet 13 or 15 as imaged.

In step S33, the high speed processor 23 increments the counter value “Ca” by one in order to count the array elements “Dif[X][Y]” having a luminance value larger than the threshold value “ThL”.

In step S34, the high speed processor 23 performs the process of calculating the minimum X-coordinate “minX”, maximum X-coordinate “maxX”, minimum Y-coordinate “minY” and maximum Y-coordinate “maxY” of the sword 11 in the differential image with reference to the array elements “Dif[X][Y]”. This point will be explained with reference to drawings.

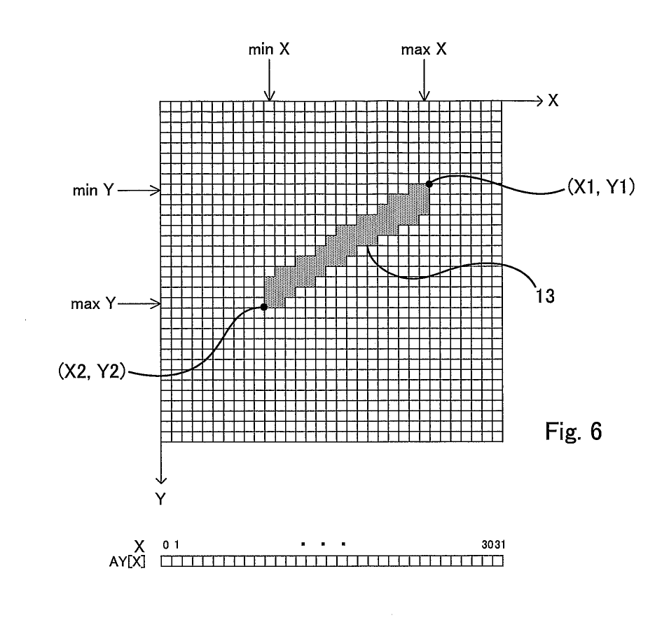

FIG. 6 is a schematic representation of the sword 11 in the differential image based on the images output by the image sensor 19 of FIG. 2 FIG. 6 illustrates an example in the case where the retroreflective sheet 13 of the sword 11 is imaged. As shown in FIG. 6, the process in step S34 of FIG. 5 is the process of calculating the minimum X-coordinate “minX”, maximum X-coordinate “maxX”, minimum Y-coordinate “minY” and maximum Y-coordinate “maxY” of the sword 11 in the differential image (32×32 pixels), and when it is confirmed that X=32 in step S47 of FIG. 5, the respective coordinates are finally determined.

FIG. 7 is a flowchart showing an example of the process of calculating the respective coordinates “minX”, “maxX”, “minY” and “maxY” in step S34 of FIG. 5. As shown in FIG. 7, the high speed processor 23 determines in step S50 whether or not the counter value “Ca” is “1”, and if it is “1” the process proceeds to step S51, otherwise the process proceeds to step S52.

In step S51, the high speed processor 23 assigns the current X-coordinate to the minimum X-coordinate “minx”. In other words, the variable “Y” is incremented from “0” to “31” with the variable “X” which is fixed until Y=31 but incremented each time the variable “Y” is returned to “0” and the variable “Y” is incremented again from “0” to “31” (refer to steps S43 to S47 of FIG. 5), and thereby the value “X” of the first array element “Dif[X][Y]” (i.e., pixel) exceeding the threshold value “ThL” is necessarily the minimum X-coordinate “minx”.

In step S52, the high speed processor 23 compares the current X-coordinate with the current maximum X-coordinate “maxX”. If the current X-coordinate is larger than the current maximum “X-coordinate “maxX” in step S53, the high speed processor 23 proceeds to step S54, otherwise proceeds to step S55. In step S54, the high speed processor 23 assigns the current X-coordinate to the maximum X-coordinate “maxX”.

In step S55, the high speed processor 23 compares the current Y-coordinate with the current minimum Y-coordinate “minY”. If the current Y-coordinate is smaller than the current minimum Y-coordinate “minY” in step S56, the high speed processor 23 proceeds to step S57, otherwise proceeds to step S58. In step S57, the high speed processor 23 assigns the current Y-coordinate to the minimum Y-coordinate “minY”.

In step S58, the high speed processor 23 compares the current Y-coordinate with the current maximum Y-coordinate “maxY”. If the current Y-coordinate is larger than the current maximum Y-coordinate “maxY” in step S59, the high speed processor 23 proceeds to step S60, otherwise the process is returned. In step S60, the high speed processor 23 assign the current Y-coordinate to the maximum Y-coordinate “maxY”.

The minimum X-coordinate “minX”, maximum X-coordinate “maxX”, minimum Y-coordinate “minY” and maximum Y-coordinate “maxY” are finally determined when X=32 (refer to step S47 of FIG. 5) after repeating the above steps S50 to S60.

Returning to FIG. 5, the high speed processor 23 compares the array element “Dif[X][Y]” with the current maximum luminance value “CMAX” in step S35. If the array element “Dif[X][Y]”, i.e., the luminance value of the pixel located in the current X-coordinate and the current Y-coordinate, is larger than the current maximum luminance value “CMAX” in step S36, then the high speed processor 23 proceeds to step S37, otherwise proceeds to step S39.

In step S37, the high speed processor 23 assigns the current Y-coordinate to the array element “AY[X]”. While this array AY has 32 elements corresponding to the X-coordinates (0 to 31) as illustrated in FIG. 6, the Y-coordinate of the pixel that has the maximum luminance value among the 32 pixels having the same X-coordinate (located in the same column) has been assigned to the array element “AY[X]” when Y=32 (refer to step S44). In step S38, the current array element “Dif [X][Y]” is assigned to the maximum luminance value “CMAX”.

Returning to FIG. 5, in step S39, the high speed processor 23 compares the array element “Dif[X][Y]” with the current maximum luminance value “LMAX”. If the array element “Dif[X][Y]” is larger than the current maximum luminance value “LMAX” in step S40, and the process proceeds to step S41, otherwise proceeds to step S43. In step S41, the high speed processor 23 assigns the current X-coordinate and the current Y-coordinate respectively to the coordinates “Xm” and “Ym”. In step S42, the high speed processor 23 assigns the array element “Dif[X][Y]” to the current maximum luminance value “LMAX”. When X=32 (refer to step S47), the X-coordinate and the Y-coordinate of the pixel having the maximum luminance value among the 32×32 pixels are assigned to the coordinates “Xm” and “Ym”. Then, the coordinate “Xm” and the coordinate “Ym” are recognized as the center X-coordinate and the center Y-coordinate of the sword 11.

In step S43, the high speed processor 23 increments the index “Y” by one. If Y=32 in step S44 (i.e., if all the pixels on one column of the differential image have been processed), the high speed processor 23 proceeds to step S45, otherwise the high speed processor 23 proceeds to step S31.

In step S45, the high speed processor 23 assigns “0” to the index “Y” and the maximum luminance value “CMAX”. In step S46, the high speed processor 23 increments the index “X” by one. Since one column of the differential image is completely processed, the steps S45 and S46 are taken for repeating the process for the next column.

If X=32 in step S47 (i.e., when the process of the 32×32 pixels of the differential image is finished), the high speed processor 23 proceeds to step S48, otherwise the high speed processor 23 proceeds to step S31.

The high speed processor 23 determines in step S48 whether or not the counter value “Ca” is larger than the predetermined value “ThA”, and if the counter value “Ca” is larger the process is returned, otherwise the process proceeds to step S8 of FIG. 3. The final counter value “Ca” indicates the number of the pixels having a luminance value which exceeds the threshold value “ThL” and is proportional to the area of the retroreflective sheet 13 or 15 in the differential image. Accordingly, it is determined that when the counter value “Ca” is larger than the predetermined value “ThA” (i.e., the retroreflective sheet 13 is directed toward the image sensor 19), the retroreflective sheet 13 which has a larger area is imaged, and that when the counter value “Ca” is no larger than the predetermined value “ThA” (i.e., the retroreflective sheet 15 is directed toward the image sensor 19) the retroreflective sheet 15 which has a smaller area is imaged.

The process in steps S5 to S7 is the process when the high speed processor 23 determines that the retroreflective sheet 13 is imaged. When it is determined that the retroreflective sheet 15 is imaged, the speed and moving direction of the sword 11 which is swung by the player 17 are calculated in step S8 on the basis of the center coordinates (Xm, Ym) of the retroreflective sheet 15, followed by performing information processes by the use of the result of the calculation.

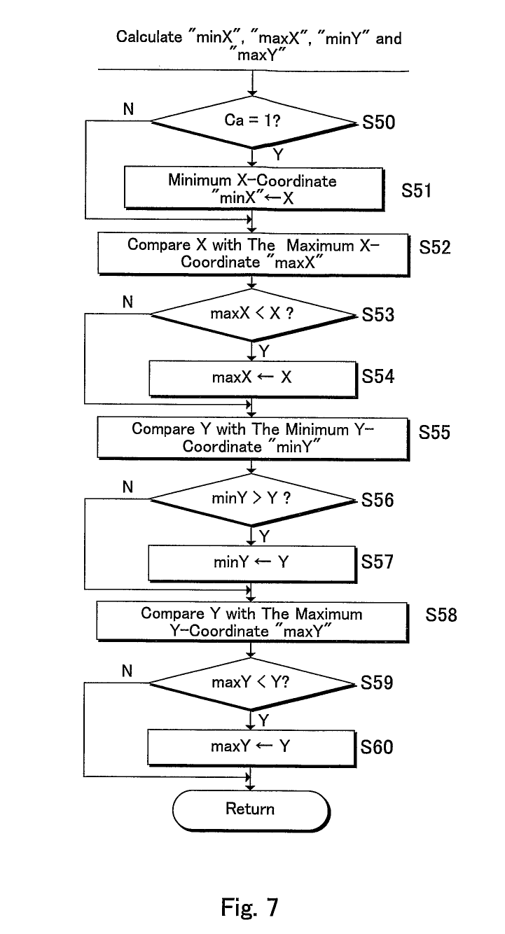

FIG. 8 is a flowchart showing an example of the process of vertical/horizontal judgment in step S5 of FIG. 3. As shown in FIG. 8, the high speed processor 23 performs the subtraction of maxX−minX in step S70 in order to obtain the width “wX” in the horizontal direction of the rectangle defined by the coordinate (minX, minY), the coordinate (minX, maxY), the coordinate (maxX, minY) and the coordinate (maxX, maxY). In the same manner, the high speed processor 23 performs the subtraction of maxY−minY in order to obtain the width “wY” the vertical direction of the above rectangle.

In step S71, the high speed processor 23 compares the horizontal width “wX” with a predetermined value “CX”. If the horizontal width “wX” is smaller than the predetermined value “CX1” in step S72, and the process proceeds to step S73 otherwise proceeds to step S77. In step S73, the high speed processor 23 compares the vertical width “wY” with a predetermined value “CY1”. If the vertical width “wY” is larger than the predetermined value “CY1” in step S74, and the process proceeds to step S75 otherwise proceeds to step S77.

Since it is assumed that CX1<CY1 in the present embodiment, it is judged that the state of the sword 11 is vertical in the case where wX<CX1 and wY>CY1. This is because the retroreflective sheet 13 is formed longer in the longitudinal direction of the sword 11 and shorter in the width direction of the sword 11. Accordingly, in step S75, the high speed processor 23 assigns “90” indicative of 90 degrees to the tilt angle “An” of the sword 11, and the process proceeds to step S7 of FIG. 3.

On the other hand, in step S77, the high speed processor 23 compares the horizontal width “wX” with a predetermined value “CX2”. If the horizontal width “wX” is larger than the predetermined value “CX2” in step S78, the process proceeds to step S79 otherwise the process is returned. In step S79, the high speed processor 23 compares the vertical width “wY” with a predetermined value “CY2”. If the vertical width “wY” is smaller than the predetermined value “CY2” in step S80, the process proceeds to step S81 otherwise the process is returned.

Since it is assumed that CX2>CY2 in the present embodiment, it is judged that the state of the sword 11 is horizontal in the case where wX>CX2 and wY<CY2. This is because the retroreflective sheet 13 is formed longer in the longitudinal direction of the sword 11 and shorter in the width direction of the sword 11. Incidentally, it is assumed that CX1=CY2 and CX2=CY1. Accordingly, in step S81 the high speed processor 23 assigns “0” indicative of 0 degree to the tilt angle “An” of the sword 11, and the process proceeds to step S7 of FIG. 3.

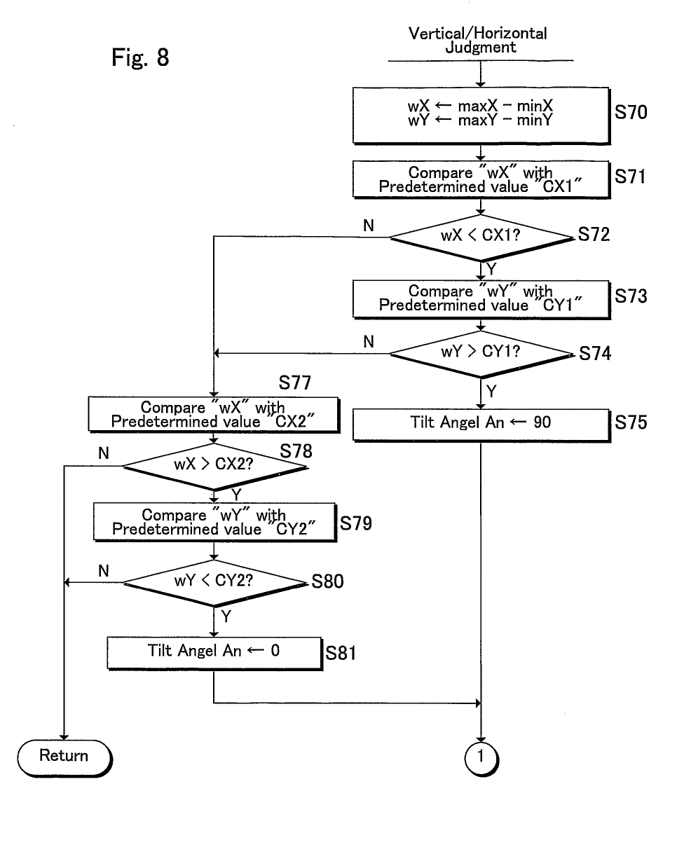

FIG. 9 is a flowchart showing an example of the process of calculating the tilt of the sword 11 in step S6 of FIG. 3. As shown in FIG. 9, in step S90, the high speed processor 23 compares the array element “AY[X]” where X is the maximum X-coordinate “maxX”, i.e., “AY[maxX]” with the array element “AY[X]” where X is the minimum X-coordinate “minX”, i.e., “AY[minX]”.

In this case, the element “AY[maxX]” is the Y-coordinate of the pixel having the maximum luminance value “CMAX” among the 32 pixels of which the X-coordinates are the maximum X-coordinate “maxX”. The element “AY[minX]” is the Y-coordinate of the pixel having the maximum luminance value “CMAX” among the 32 pixels of which the X-coordinate is the minimum X-coordinate “minX”.

If the element “AY[maxX]” is larger than the element “AY[minX]” in step S91, the high speed processor 23 proceeds to step S92 otherwise proceeds to step S93.

In this case, the element “AY[maxX]” larger than the element “AY[minX]” means that the sword 11 (the retroreflective sheet 13) tilts upward to the right (like the retroreflective sheet 13 as illustrated in FIG. 6). Accordingly, in step S92, (maxX, minY) and (minX, maxY) are assigned respectively to the coordinates (X1, Y1) of a first characteristic point and the coordinates (X2, Y2) of a second characteristic point which are used to calculate the tilt angle “An” (refer to FIG. 6).

On the other hand, the element “AY[maxX]” smaller than the element “AY[minX]” means that the sword 11 (the retroreflective sheet 13) tilts downward to the right (like the retroreflective sheet 13 of FIG. 6 as horizontally flipped). Accordingly, in step S93, (min X, minY) and (max X, maxY) are assigned respectively to the coordinates (X1, Y1) and (X2, Y2) which are used to calculate the tilt angle “An”.

In step S94, the high speed processor 23 calculates the tilt angle “An” of the sword 11 on the basis of the coordinates (X1, Y1) and (X2, Y2). In the case of the present embodiment, the tilt angle “An” is calculated as a counter-clockwise angle with reference to the horizontal direction. The tilt angle “An” will be explained with reference to the drawings.

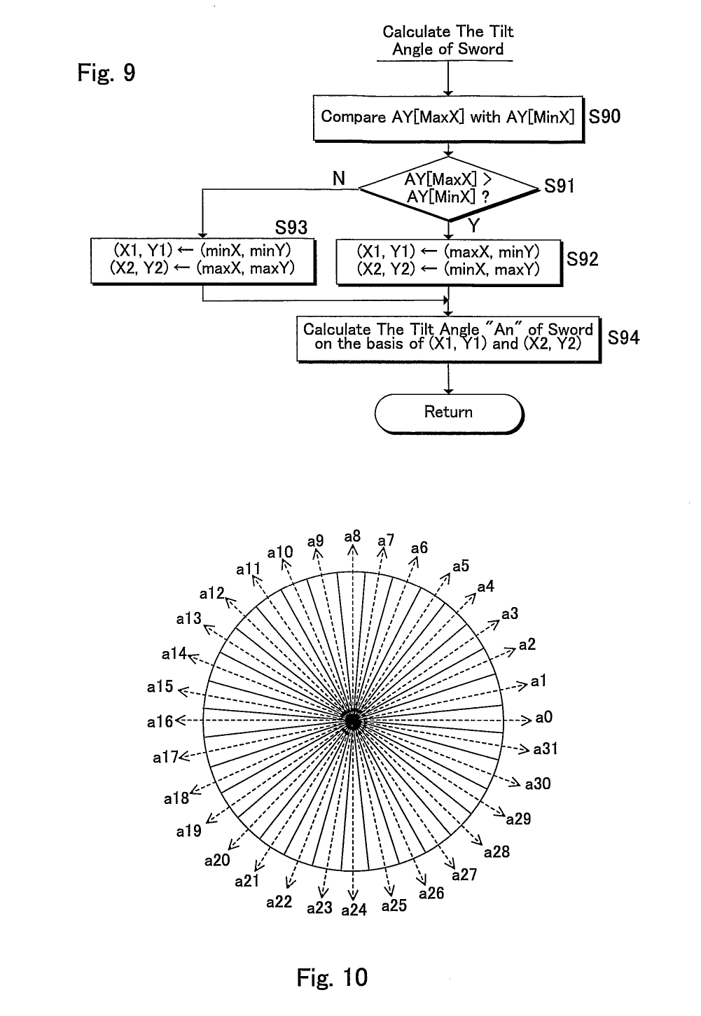

FIG. 10 is an explanatory view for showing the tilt and sense of the sword 11 as determined by the game unit 1 of FIG. 1. As shown in FIG. 10, in the case of the present embodiment, 360 degrees is divided by 32 such that one orientation is assigned to each 11.25 degrees. In other words, 32 orientations a0 to a31 are defined. However, while the tilt of the sword 11 can be determined by the process of FIG. 9, it is impossible to determine the sense of the sword 11. An example follows.

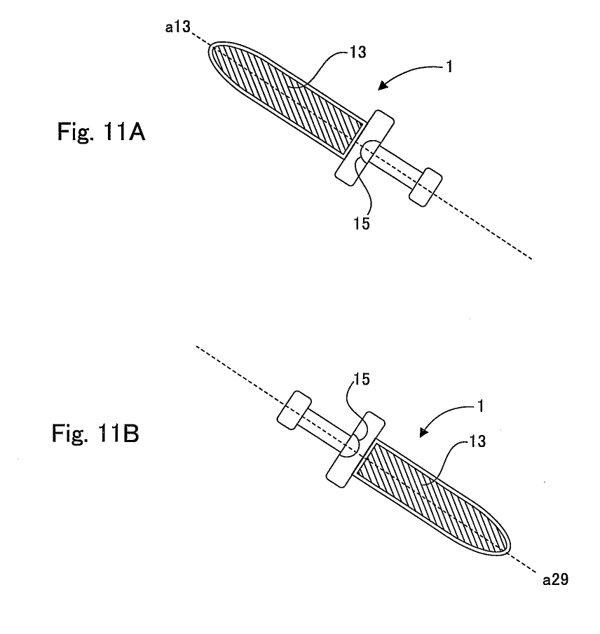

FIG. 11A is a view showing the sword 11 directed to the orientation a13 of FIG. 10, and FIG. 11B is a view showing the sword 11 directed to the orientation a29 of FIG. 10. As can be seen from the figures, the sword 11 can have the same tilt and different senses. The sense of the sword 11 cannot be determined by the process of FIG. 9.

Namely, the tilt angle “An” calculated on the basis of the coordinates (X1, Y1) and (X2, Y2) are obtained within the range of 0 to 180 degrees. Accordingly, for example, in the case where the tilt angle “An” is 100 degrees, there are two orientations a9 and a25 corresponding to 100 degrees so that it is impossible to distinguish one from the other. In order to deal with this problem, step S7 of FIG. 3 is performed.

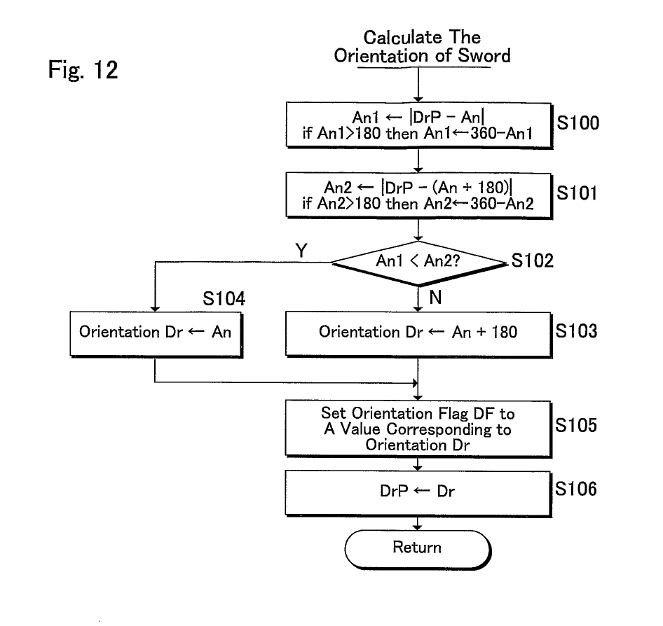

FIG. 12 is a flowchart showing an example of the process of detecting the orientation of the sword 11 in step S7 of FIG. 3. As shown in FIG. 12, in step S100, the high speed processor 23 assigns the absolute value of the difference between the previous orientation “DrP” of the sword 11 and the current tilt angle “An” to the differential angle “An1”. However, if the differential angle “An1” is larger than 180 degrees, (360—“An1”) is used in place of the differential angle “An1”.

In this case, the orientation “DrP” is obtained in the range of 0 to 360 degrees (refer to step S106) in angular degrees. In other words, the orientation “DrP” can indicate the previous orientation (tilt and sense) of the sword 11. Accordingly, the process of step S100 is the process for obtaining the differential angle between the previous orientation “DrP” of the sword 11 and a first candidate of the current orientation “Dr” of the sword 11 (that is, the tilt angle “An”).

In step S101, the high speed processor 23 assigns the absolute value of the difference between the previous orientation “DrP” of the sword 11 and the current tilt angle “An” plus 180 degrees to the differential angle “An2”. However, if the differential angle “An2” is larger than 180 degrees, (360—“An2”) is used in place of the differential angle “An2”.

The current tilt angle “An” plus 180 degrees is a second candidate of the current orientation “Dr” of the sword 11. Accordingly, the process of step S101 is the process for obtaining the differential angle between the previous orientation “DrP” of the sword 11 and the second candidate of the current orientation “Dr” of the sword 11 (that is, the tilt angle “An” plus 180 degrees).

The high speed processor 23 compares the differential angle “An1” and the differential angle “An2” in step S102, and if the differential angle “An1” is smaller, the process proceeds to step S104 otherwise proceeds to step S103. The differential angle “An1” smaller than the differential angle “An2” means that the first candidate of the current orientation “Dr” of the sword 11 is closer to the previous orientation “DrP” than the second candidate is. For this reason, in step S104, the high speed processor 23 assigns the first candidate (tilt angle “An”) to the current orientation “Dr”.

On the other hand, the differential angle “An2” smaller than the differential angle “An1” means that the second candidate of the current orientation “Dr” of the sword 11 is closer to the previous orientation “DrP” than the first candidate is. For this reason, in step S103, the high speed processor 23 assigns the second candidate (tilt angle “An” plus 180 degrees) to the current orientation “Dr”.

In step S105, the high speed processor 23 sets an orientation flag “DF” indicative of the orientation of the sword 11 to a value corresponding to the orientation “Dr”. Namely, it is determined which of the orientations a0 to a31 of FIG. 10 the orientation “Dr” belongs to, and the orientation flag “DF” is set to a value corresponding to one of the orientations a0 to a31 to which the orientation “Dr” belongs.

In step S106, the high speed processor 23 assigns the current orientation “Dr” to the orientation “DrP”, and the orientation “DrP” as updated is used to calculate the next orientation “Dr”.

Incidentally, an angle in the range of 0 to 180 degrees is assigned to the orientation “DrP” as an initial value (in step S1 of FIG. 3).

Returning to FIG. 3, when the retroreflective sheet 13 is detected, in step S8, the high speed processor 23 stores the storage location information of a beltlike object corresponding to the orientation flag “DF” and the center coordinates (Xm, Ym) of the retroreflective sheet 13 in the internal memory, Namely, this process is performed in order to display the beltlike object on the television monitor 7 corresponding to the orientation “Dr” of the sword 11 when the retroreflective sheeting 13 is detected. Incidentally, this process is only part of the process in step S8.

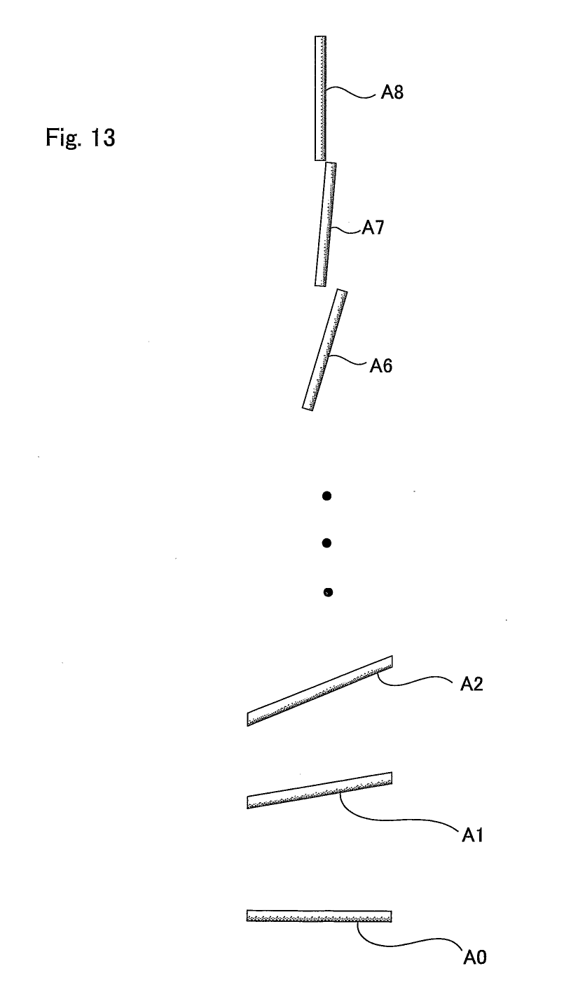

FIG. 13 is a view showing examples of beltlike objects A0 to A8 provided in the ROM 25 in the case of the present embodiment. The beltlike objects A0 to A8 of FIG. 13 correspond respectively to the orientations a0 to a8 of FIG. 10. Accordingly, in the case where the orientation flag “DF” of the sword 11 indicates one of the orientations a0 to a8, the corresponding one of the beltlike objects A0 to A8 is used and displayed as it is. In the case where the orientation flag “DF” of the sword 11 indicates one of the orientations a9 to a16, the corresponding one of the beltlike objects A7 to A0 is used and displayed after horizontally flipping it. In the case where the orientation flag “DF” of the sword 11 indicates one of the orientations a17 to a23, the corresponding one of the beltlike objects A1 to A7 is used and displayed after horizontally and vertically flipping it. In the case where the orientation flag “DF” of the sword 11 indicates one of the orientations a24 to a31, the corresponding one of the beltlike objects A8 to A1 is used and displayed after vertically flipping it.

Returning to FIG. 3, in step S10, the high speed processor 23 reads the image information of a beltlike object from the ROM 25 on the basis of the storage location information of the beltlike object stored in the internal memory in step S8, performs necessary processes, and displays the beltlike object in the position corresponding to the center coordinates (Xm, Ym) of the sword 11. In this case, the center position of the beltlike object is aligned with the position corresponding to the center coordinates (Xm, Ym) of the sword 11. Although this explanation centers on the beltlike objects, other processes for displaying a background image and other image objects are also performed.

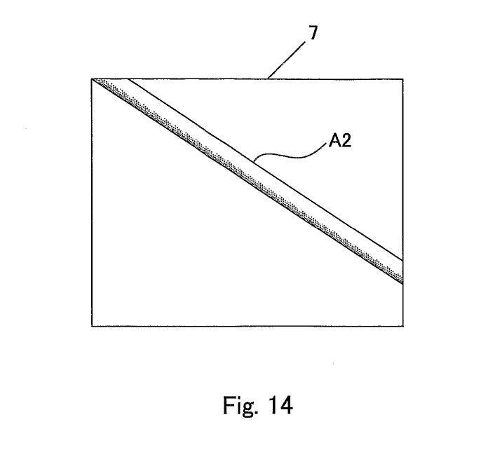

FIG. 14 is a view showing an example of the beltlike object A2 as displayed on the television monitor 7 of FIG. 1. As shown in FIG. 14, the beltlike object A2 is horizontally flipped when displayed on the television monitor 7. Accordingly, in this example, the beltlike object is displayed corresponding to the sword 11 which is oriented as illustrated in FIG. 11A while the orientation flag “DF” indicates the orientation a13. As thus described, a beltlike object is displayed on the television monitor 7 corresponding to the orientation indicated by the orientation flag “DF” (i.e., the orientation of the sword 11).

As has been discussed above, in accordance with the present embodiment, the maximum X-coordinate “maxX”, minimum X-coordinate “minX”, maximum Y-coordinate “maxY” and minimum Y-coordinate “minY” of the sword 11 in the differential image are obtained. Then, the pixel having the maximum luminance value among a plurality of pixels of which the X-coordinates are the maximum X-coordinate “maxX” is detected to acquire the Y-coordinate “AY[maxX]” of the pixel, while the pixel having the maximum luminance value among a plurality of pixels of which the X-coordinates are the minimum X-coordinate “minX” is detected to acquire the Y-coordinate “AY[minX]” of the pixel. Furthermore, the first characteristic point (X1, Y1) and the second characteristic point (X2, Y2) are determined on the basis of the result of comparing the Y-coordinate “AY[maxX]” and the Y-coordinate “AY[minX]”, and the tilt angle “An” of the sword 11 is calculated. In this way, in accordance with the present embodiment, it is possible to detect the tilt of the sword 11 on the basis of stroboscopic images of the retroreflective sheet 13 attached to the sword 11.

Also, in accordance with the present embodiment, the horizontal width “wX” and the vertical width “wY” of the rectangle defined by the coordinate (minX, minY), the coordinate (minX, maxY), the coordinate (maxX, minY) and the coordinate (maxX, maxY) are obtained. Then, the ratio wX/wY is used to determine if the sword 11 is vertical or horizontal. In this way, when the sword 11 is imaged with a particular tilt (horizontal or vertical), it is possible to appropriately determine such a particular tilt.

Furthermore, in accordance with the present embodiment, the orientation of the sword 11 in the differential image is obtained on the basis of the orientation “DrP” of the sword 11 in the differential image as obtained in the past and the tilt angle “An” of the sword 11 in the differential image as currently obtained. It is possible to detect not only the tilt of the sword 11 but also the sense of the sword 11 in this manner.

Meanwhile, the present invention is not limited to the above embodiments, and a variety of variations and modifications may be effected without departing from the spirit and scope thereof, as described in the following exemplary modifications.

(1) Although the operation article 11 is sword-like as an example in the above explanation, the shape of the operation article is not limited thereto. Also, the profile of the retroreflective sheet for obtaining the tilt and orientation of the operation article is not limited to the profile of the retroreflective sheet 13 as illustrated in FIG. 1. Accordingly, as long as the aspect ratio (ratio of the width to the height) of the general outline is not equal to “1”, smaller portions of the retroreflective sheet can be arbitrarily designed.

(2) In the case of the above example, a beltlike object selected corresponding to the orientation of the sword 11 is displayed on the television monitor 7. However, the object to be displayed corresponding to the orientation of the sword 11 is not limited thereto, but any object having an arbitrary profile or configuration (for example, an object having the shape of a sword and so forth) can be displayed.

(3) Although the tilt angle “An” is obtained as an angular degree in FIG. 9 and the differential angles “An1” and “An2” and the orientation “Dr” are calculated by directly assigning this angular degree in FIG. 12, the expression of an angle is not limited thereto, but it is possible to use any appropriate representation which may indirectly indicates an angle.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. A tilt detection method of detecting a tilt of an operation article which is held and given motion by an operator, comprising:
a step of repeatedly emitting light to the operation article which has a reflecting object in a predetermined cycle;
a step of imaging the operation article to which the light is emitted, and acquiring lighted image data including a plurality of pixel data items each of which comprises a luminance value;
a step of imaging the operation article to which the light is not emitted, and acquiring unlighted image data including a plurality of pixel data items each of which comprises a luminance value;
a step of generating differential image data by obtaining difference between the lighted image data and the unlighted image data;
a step of obtaining a maximum X-coordinate of the operation article in a differential image on the basis of the differential image data;
a step of obtaining a minimum X-coordinate of the operation article in the differential image;
a step of obtaining a maximum Y-coordinate of the operation article in the differential image;
a step of obtaining a minimum Y-coordinate of the operation article in the differential image;
a step of detecting a pixel data item having a maximum luminance value from among a plurality of pixel data items of the differential image data whose X-coordinates are the maximum X-coordinate, and acquiring the Y-coordinate of the pixel data item;
a step of detecting a pixel data item having a maximum luminance value from among a plurality of pixel data items of the differential image data whose X-coordinates are the minimum X-coordinate, and acquiring the Y-coordinate of the pixel data item;
a step of comparing the Y-coordinate of the pixel data item having the maximum luminance value whose X-coordinate is the maximum X-coordinate and the Y-coordinate of the pixel data item having the maximum luminance value whose X-coordinate is the minimum X-coordinate, and determining which is greater;
a step of obtaining the coordinates of a first characteristic point and the coordinates of a second characteristic point of said operation article in the differential image on the basis the result of the determination, the maximum X-coordinate, the minimum X-coordinate, the maximum Y-coordinate and the minimum Y-coordinate; and
a step of obtaining the tilt of the operation article in the differential image on the basis of the coordinates of the first characteristic point and the coordinate of the second characteristic point.

2. The tilt detection method as claimed in claim 1 further comprising:
a step of obtaining the difference between the maximum X-coordinate and the minimum X-coordinate;
a step of obtaining the difference between the maximum Y-coordinate and the minimum Y-coordinate; and
a step of obtaining the tilt of the operation article in the differential image in accordance with the ratio of the difference between the maximum X-coordinate and the minimum X-coordinate to the difference between the maximum Y-coordinate and the minimum Y-coordinate.

3. The tilt detection method as claimed in claim 1 further comprising:
a step of obtaining the orientation of the operation article in the differential image on the basis of the orientation of the operation article as obtained in the past and the tilt of the operation article as currently obtained.

4. The tilt detection method as claimed in claim 2 further comprising:
a step of obtaining the orientation of the operation article in the differential image on the basis of the tilt and orientation of the operation article as obtained in the past and the tilt of the operation article as currently obtained.

5. An entertainment system comprising:
an operation article that is operated by a user when the user is enjoying said entertainment system;
an imaging unit having a light emitting device operable to emit light to said operation article, and an image sensor operable to detect the light reflected by said operation article and acquire images of said operation article in different times; and
an information processing apparatus connected to said image sensor, and operable to receive the images of said operation article from said image sensor and determine orientations of said operation article on the basis of the images of said operation article,
wherein a tilt of an orientation of said operation article is calculated on the basis of the corresponding one of the images of said operation article acquired by said imaging unit, and
wherein a sense of an orientation of said operation article in a current image obtained by said imaging unit is determined by calculating the differential angle between each of two possible candidates of the orientation having the same tilt and a previous orientation determined on the basis of the image that is obtained by said imaging unit and timely preceding the current image, and selecting one of the two possible candidates having the smaller differential angle.
